(19) United States
(12) Patent Application Publication
(10) Pub. No.: US 2014/0130243 A1
(43) Pub. Date: May 15, 2014

(54) Conventional sewn-in single layer garment pocket with electromagnetic radiation attenuation

(71) Applicants: Robert Falken, Oceanside, CA (US); Steve Lake, Encinitas, CA (US)

(72) Inventors: Robert Falken, Oceanside, CA (US); Steve Lake, Encinitas, CA (US)

(21) Appl. No.: 13/673,712

(22) Filed: Nov. 9, 2012

(51) Int. Cl. G21F 1/00; A41D 27/20

(52) U.S. Cl. CPC G21F 1/00; A41D 27/204
USPC 2/455; 2/247

(57) ABSTRACT

A conventional sewn-in single layer garment pocket with electromagnetic radiation attenuation that creates a shield between the garment wearer and an electromagnetic radiation-emitting device placed within the pocket.

### FIELD OF THE INVENTION

The present invention relates generally to the field of electromagnetic radiation attenuating devices, and in particular to conventional sewn-in single layer pants pockets for cellular telephones and other portable electronic devices producing electromagnetic radiation emissions, the conventional sewn-in single layer pocket permitting operation of the cellular telephone or other electronic device while providing a convenient temporary shield from harmful electromagnetic radiation emissions thereof.

### BACKGROUND OF THE INVENTION

Cellular telephone subscriptions are currently estimated at 5.9 billion globally and the use is expected to continue growing. Despite the fact that cellular telephones have been cited as a source of high amounts of electromagnetic radiation, people continue to use them. Electromagnetic radiation emitted from a cellular telephone generally directs towards the closest part of the users body. This radiation is capable of causing some level of reproductive harm to both men and women, especially after prolonged use. Some evidence has even linked cellular telephone electromagnetic radiation emissions to cancer. This invention is intended to provide cellular telephone users a convenient means to temporarily shield themselves from such risks.

Proper shielding can help protect against electromagnetic radiation and the resulting health problems caused by over exposure.

Radiation shields are known in the art. Cellular telephone electromagnetic radiation protection devices are designed to shield radiation in the form of a case on the cellular telephone, by affixing a device system to the garment, as a radiation blocking portable pouch, or through the use of a hands-free device.

However, known electromagnetic radiation protection devices are limited in their ability to provide the necessary protection quickly and in a convenient manner that is familiar to the user.

Prior art can be found in US Pub. No. 2012/0185999 A1 to Raviv et al.

However, such prior art is cumbersome and presents non-conventional means to house an emitting device in a manner that changes the traditional construction of the garment.

There is much debate in the media today about electromagnetic radiation possibly causing biological change and reproductive harm to humans. The link between radiation exposure and dose is not yet fully understood. However inconclusive the evidence is, there is reason enough for prudent avoidance.

### SUMMARY OF THE INVENTION

The present invention is a conventional sewn-in single layer pants pocket with electromagnetic radiation attenuation for a cellular telephone or other portable electronic device producing electromagnetic radiation emissions.

According to one aspect of the invention, the conventional sewn-in single layer attenuating pocket includes metal containing fibers disposed within a natural or synthetic fabric, or a blend thereof, to form a conventional sewn-in single layer pocket large enough to contain a cellular telephone or other portable electronic device producing electromagnetic radiation emissions.

According to another aspect of the invention, a method is provided of forming a conventional sewn-in single layer pants pocket with electromagnetic radiation attenuation, wherein the sewn-in single layer electromagnetic radiation attenuating pocket is formed by coupling walls of the electromagnetic radiation attenuating fabric together along corresponding peripheral base and opposing side edges, thus forming a conventional single layer pocket. The pocket is sewn into the pants by ordinary means known by those skilled in the art and positioned to hang on the inner side of the garment in conventional locations.

According to another aspect of the invention, a method is provided of forming a conventional sewn-in single layer pants pocket with electromagnetic radiation attenuation, wherein there is provided a method by which a user can conveniently utilize temporary shielding from electromagnetic radiation without the need of altering the users cellular telephone or device, without unconventional garment construction, without the need for a shielding portable pouch, and without the need of attached objects to the electromagnetic radiation-emitting device.

Additional features and advantages of the invention will be apparent from the detailed description which follows, taken in conjunction with the accompanying drawings, which together illustrate, by way of example, features of embodiments of the present invention.

### BRIEF DESCRIPTION OF THE DRAWING

The following drawings illustrate exemplary embodiments for carrying out the invention. Like reference numerals refer to like parts in different views or embodiments of the present invention in the drawings.

FIG. 1 is a perspective view showing the outer side of the front side portion of a pair of pants including a conventional sewn-in single layer electromagnetic radiation attenuating pocket structure for a cellular telephone or other portable electronic device producing electromagnetic radiation emissions, with the pocket on the inside of the garment illustrated with phantom lines.

FIG. 2 is a cross sectional view taken along line 2-2 of the pocket structure shown in FIG. 1.

FIG. 3 shows the embodiment of the pocket structure of the invention.

FIG. 4 shows an alternate embodiment of the pocket structure of the invention.

FIG. 5 illustrates operation of the conventional sewn-in single layer pants pocket with electromagnetic radiation attenuation of the invention.

### DETAILED DESCRIPTION OF PREFERRED EMBODIMENT

The pocket structure of the present invention is described herein in the context of an electromagnetic radiation attenuating front pocket for pants, although those skilled in the art will recognize that the invention may also be used in numerous other garments and for other pockets on pants.

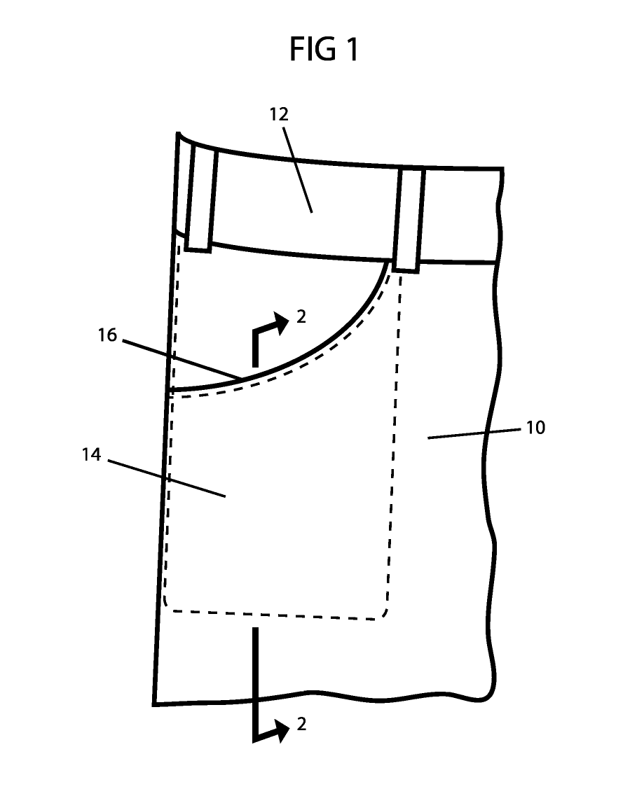

Referring first to FIG. 1, the outer side of the front side portion of a pair of pants is shown. The pants include a body 10 made of fabric. A waistband 12 of substantially conventional construction is included at the top of the garment. Depending on or hanging from the waistband is an electromagnetic radiation attenuating pocket structure 14 constructed according to the invention. In conventional fashion, a pocket opening 16 through the pocket fabric provides access to the pocket, as is described herein.

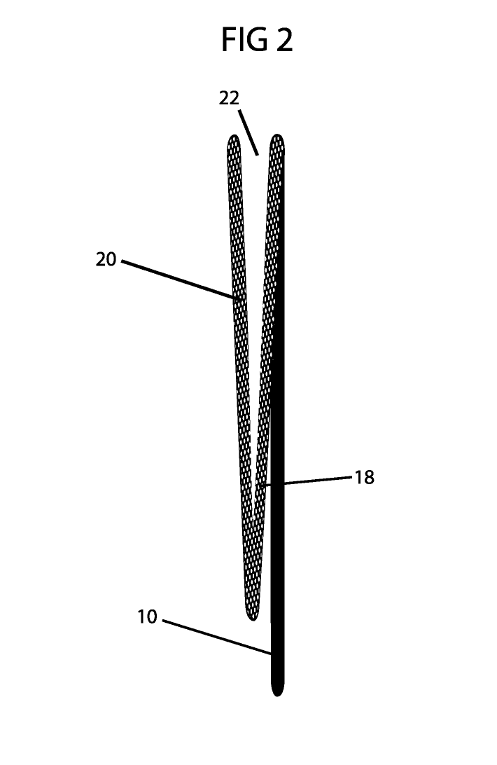

Referring to the cross-section shown in FIG. 2, the pocket structure includes a single layer pocket that is formed of two opposed walls 18 and 20 of electromagnetic radiation attenuating fabric attached to each other along their edges to form a pocket space 22 between them. As is typical, the pocket hangs on the inner side of the garment, adjacent the inner side of the garment fabric 10. The first pocket wall 18 may be adjacent and opposed to the inner side of the garment fabric. The first wall 18 may then be referred to as the “outer” pocket wall and the second wall 20 may be referred to as the “inner” pocket wall.

The first and second pocket walls 18 and 20 may have essentially the same shape below the pocket opening 16. For the pants front pocket shown, the distance from the pocket opening 16 to the bottom of the pocket space 22 may be approximately 6.5 to 7.5 inches. The second wall 20 may have a total length of approximately ten inches to provide a sufficient amount to sew into the waistband 12. The first wall 18 may be 6.75 to 7.75 inches to extend to the pocket opening 16. The top edge of the first wall 18 may or may not be attached to the second wall 20. The first and second walls are preferably slightly wider than the pocket opening 16 so that the garment fabric 10 can be stitched to the first pocket wall 18 all around the fabric pocket opening 16.

For certain pockets, the first and second walls 18 and 20 may be formed of a single piece of electromagnetic radiation attenuating fabric folded approximately in half and stitched along its free edges, rather than two separate pieces of fabric.

According to one embodiment, the walls 18 and 20 of electromagnetic radiation attenuating fabric are formed of STATICOT™ shielding fabric. STATICOT™ shielding fabric is a polyester/cotton blend with microfine stainless steel fibers in a tough fabric similar to khaki, specifically a blend of 34 percent polyester, 41 percent combed cotton and 25 percent high shielding metal fiber, which is washable, cuttable and sewable.

One alternative fabric for the walls 18 and 20 of electromagnetic radiation attenuating fabric include, by example and without limitation, Farabloc® described in incorporated U.S. Pat. Nos. 4,653,473, 4,825,877, 6,146,351, and 6,868,854. In various examples of such fabrics disclosed in the incorporated references, the fabric includes between about 2% and about 35% by weight of the conductive fibers. Any suitably optimized fabric composition can be used in a given situation.

Additionally, any suitable electromagnetic radiation attenuating fabric can be employed that incorporates conductive fibers (metal, carbon nanotubes, or other conductive fibers) of any suitable type to form a substantially continuous electrical conduction network in the fabric. The conduction network can be arranged in any suitable arrangement. The conductive fibers can be intermingled with non-conductive fibers to form the shielding fabric. Examples of suitable fibers include typical textile fibers, e.g., silk, wool, or other natural polyamide fibers; rayon, cotton, or other cellulosic fibers; or polyester, nylon, Kevlar, or other synthetic fibers. Alternatively, the conductive fibers can be applied to a surface of a non-conducting fabric to form the shielding fabric. In that latter case, the non-conducting fabric can comprise a woven or textile fabric. The conductive fibers can be combined with the non-conducting fabric in any suitable way, including those described above or others not explicitly disclosed herein, and all such combinations shall fall within the scope of the present disclosure.

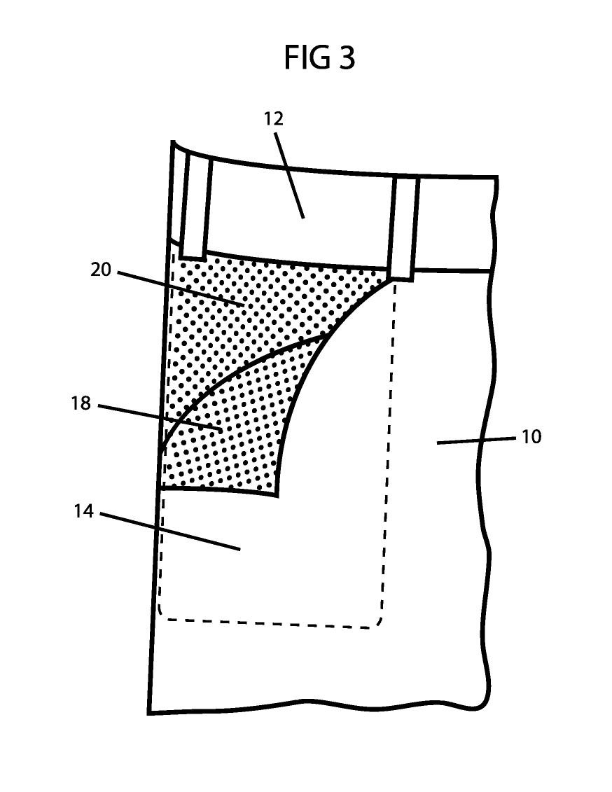

Referring now to FIG. 3, the embodiment of the pocket structure of the invention includes a sewn-in single layer pants pocket that is formed of two opposed walls 18 and 20 wherein the “outer” pocket wall 18 is formed of electromagnetic attenuating fabric, and the “inner” pocket wall 20 is formed of electromagnetic attenuating fabric. As is typical, the pocket 14 hangs on the inner side of the garment.

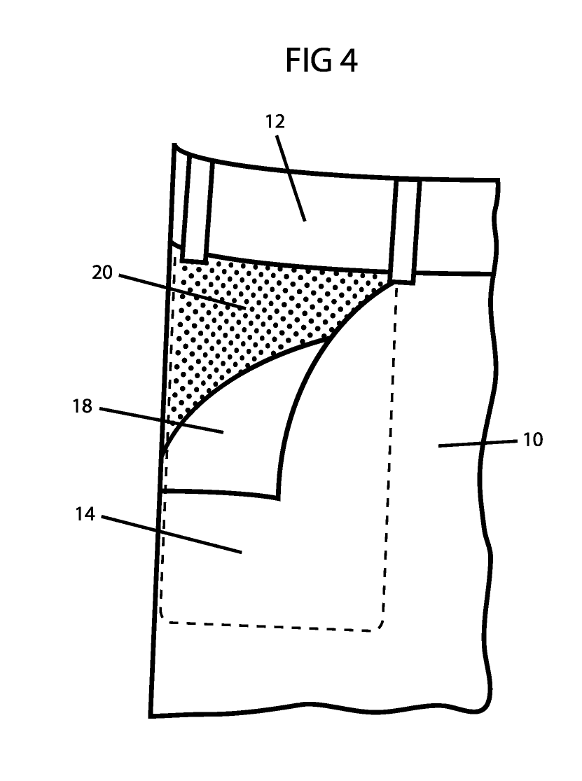

Referring now to FIG. 4, the alternate embodiment of the pocket structure of the invention includes a sewn-in single layer pants pocket that is formed of two opposed walls 18 and 20 wherein the “outer” pocket wall 18 is formed of conventional fabric, and the “inner” pocket wall 20 is formed of electromagnetic attenuating fabric. As is typical, the pocket 14 hangs on the inner side of the garment.

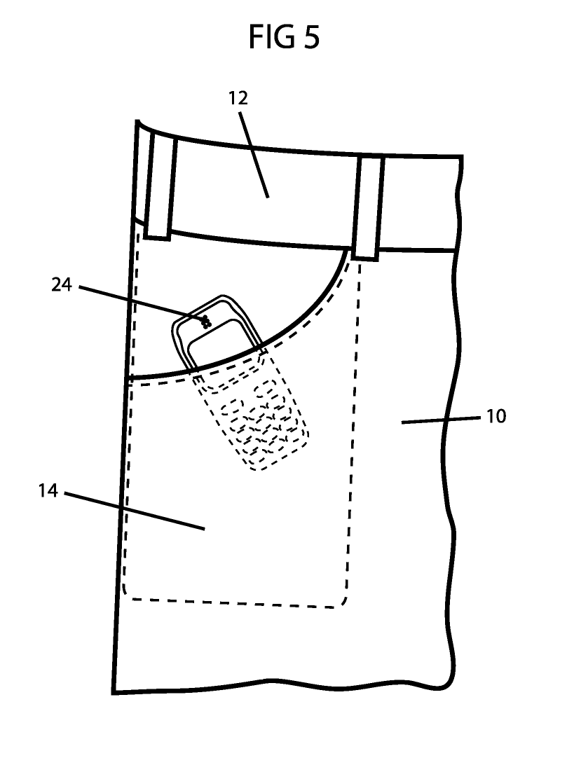

Referring now to FIG. 5, the operation of the conventional sewn-in single layer pants pocket with electromagnetic radiation attenuation is show by way of a cellular telephone 24 producing electromagnetic radiation emissions being placed within the pocket 14.

The garment pocket structure described and shown is readily constructed and installed in conventional garments. No special waistband or major special garment structure needs to be constructed, thus the pocket structure is easy and inexpensive to include in a garment.

As noted previously, although the garment pocket structure of the invention has been described by reference to embodiments intended for use with pants, those skilled in the art will recognize that the electromagnetic radiation attenuating pocket may also be used in coats, shorts, and other garments.

Numerous modifications to the structure of the embodiments described above will be obvious to those skilled in the art without departing from the essence of the invention.

What is claimed is:

1. A conventional pocket structure for a garment, wherein said garment has an inner side and an outer side and comprises fabric having a pocket opening therethrough, said pocket structure comprising:
a conventional sewn-in single layer pocket comprising first and second opposed walls of electromagnetic radiation attenuating fabric attached to one another to form a pocket space therebetween, wherein said first and second walls are attached to said garment around said pocket opening so that said pocket hangs on the inner side of said garment, and said pocket opening provides access from the outer side of said garment into said pocket space; and
the electromagnetic radiation attenuating fabric comprising the following materials:
metal containing fibers disposed within said fabric;
the electromagnetic radiation attenuating fabric further comprising natural or synthetic fibers, or a blend thereof.

2. A method of shielding the garment wearer from electromagnetic radiation emitting devices including the following steps:
1) forming two walls of electromagnetic radiation attenuating fabric; coupling the walls of fabric together along corresponding peripheral base and opposing side edges thereof; forming a conventional single layer pocket;
2) sewing the formed pocket into the garment to hang on the inner side of the garment;
3) the pocket space may be accessible from the outer side of the garment through a garment pocket opening. The two walls of electromagnetic radiation attenuating fabric may be securely attached to and depend from, the garment, such as the waistband of a pair of pants;
4) the formed pocket creates a radiation buffer zone between the emitting device and garment wearer.

3. A front pocket structure for a pair of pants, comprising:
a front pocket of conventional construction comprising first and second electromagnetic radiation attenuating fabric walls securely attached to the pants fabric, and to each other to form a pocket space therebetween.
